(19) United States
(12) Patent Application Publication
(10) Pub. No.: US 2018/0087635 A1
(43) Pub. Date: Mar. 29, 2018

(54) BALL SCREW DRIVE

(71) Applicant: SCHAEFFLER TECHNOLOGIES AG & CO. KG, Herzogenaurach (DE)

(72) Inventor: Marc HAMMANN, Mundolsheim (FR)

(73) Assignee: SCHAEFFLER TECHNOLOGIES AG & CO. KG, Herzogenaurach (DE)

(21) Appl. No.: 15/573,243

(22) PCT Filed: May 25, 2016
(86) PCT No.: PCT/DE2016/200253

§ 371 Date: Nov. 10, 2017

(30) Foreign Application Priority Data
May 27, 2015 (DE) 10 2015 209 643.2

(51) Int. Cl. F16H 25/22

(52) U.S. Cl. CPC F16H 25/2219

(57) ABSTRACT

A ball screw drive, comprising a threaded spindle that includes and an outer surface including a first ball-accommodating groove. The ball screw drive further includes a nut configured to guide on the threaded spindle and includes two or more deflecting bodies not aligned to each other in an axial direction, wherein the nut further includes an inner surface including a second ball-accommodating groove, wherein the first and second ball-accommodating groove form a ball channel. The ball screw drive also includes one or more balls arranged to transfer from one segment of the ball channel into an adjacent segment of the ball channel.

### CROSS-REFERENCE TO RELATED APPLICATIONS

This application is the U.S. National Phase of PCT/DE2016/200253 filed May 25, 2016, which claims priority to DE 102015209643.2 filed May 27, 2015, the entire disclosures of which are incorporated by reference herein.

### TECHNICAL FIELD

The disclosures relates to a ball screw drive, comprising a threaded spindle, which has a ball-accommodating groove that is formed on the outer surface of the threaded spindle and a nut, which is arranged on the threaded spindle, which has a ball-accommodating groove that is formed on the inner surface of the nut, wherein the two ball-accommodating grooves combine to form a ball channel, as well as a plurality of balls, which are arranged in the ball channel, wherein the nut is guided on the threaded spindle, wherein a plurality of deflecting bodies are arranged on the nut, wherein the balls can be transferred from one segment of the ball channel into an adjacent segment of the ball channel, wherein the deflecting bodies are offset from each other by angle segments in the channel revolving direction.

### BACKGROUND

Ball screw drives generally have the purpose to convert a rotational movement into a translation. To accomplish this, either the spindle or the nut may be connected to a drive, e.g. an electro motor, possibly via an interconnected transmission. When the spindle is rotated by using the drive, the nut, which is connected to the spindle via the balls that are arranged in the tracks, is moved in axial or in longitudinal direction of the spindle. Alternatively, it is also possible that the drive is coupled to the nut, so that the nut is set in rotation by using the drive, whereby the spindle is moved in axial direction by using the nut.

Generally, a plurality of deflecting bodies is arranged at the nut, which serve for the transferring of the balls. The balls enter via an inlet opening into the deflecting body, run through the deflecting body within a corresponding channel and then exit via an exit opening into an adjacent segment of the ball channel. Thus, enclosed ball circulations are formed.

Usually, several deflecting bodies are arranged at the nut, so that there are several separate ball circulations. The ball circulation is carried out around approximately 360°, which means that the balls are directly transferred from one channel section into the adjacent channel section via the deflecting body.

A ball screw drive of this kind is known from e.g. the DE 100 22 715 A1. The arrangement of the deflecting bodies there is made in such a way, that they are arranged with an offset of 540° to each other when viewed in the circumferential direction of the channel. This means that one deflecting body follows a preceding deflecting body after 1.5 channel threads. When views in axial direction, the deflecting bodies are thus positioned at an offset of 180° to each other. This arrangement is supposed to be especially advantageous when there are four deflecting bodies or respective ball circulations, in view of a reduction of the differences in the distribution of the load in circumferential direction. Thus, when viewed in axial direction, there are always two respective deflecting bodies that are arranged at the same position in this embodiment.

### SUMMARY

It is an objective of the disclosure to disclose a ball screw drive that has been improved in this regard, which offers a most even distribution of the load.

In order to accomplish this task, it is intended in line with the disclosure for a ball screw drive of the above-mentioned type, that the deflecting bodies, with reference to one equal body point for all deflecting bodies, are positioned with an offset of 490° towards each other.

At the ball screw drive according to the disclosure, the deflecting bodies are accordingly arranged at an offset of 490° towards each other in circumferential direction of the channel, i.e. when viewed alongside the ball channel. When viewed in axial direction, this results in a circumferential offset of 130°. When e.g. four deflecting bodies are intended, the first deflecting body would be found at a 0° position in a merely axial view, the second deflecting body at a 130° position, the third deflecting body at a 260° position and the fourth deflecting body at a 390° position. As such, the plurality of deflecting bodies may not be aligned to each other in axial direction, but rather that each deflecting body is arranged at a position that is offset in circumferential direction to that of all other deflecting bodies.

Each ball circulation via one deflecting body may stretch over approximately 360°. Within the ball circulation, the balls are guided in a larger angular section within the ball channel, and are thus load bearing, while they are guided in a much smaller angular section within the deflecting body, in which they may not be exposed to any load. Since the deflecting bodies are now set at an offset with regards to their position according to the disclosure, i.e. they are not all positioned at the same location in axial direction, the angular sections of the ball circulations, in which the balls are load bearing within the ball channel, are accordingly also set at a corresponding offset. By using the offset due to the positioning of the deflecting bodies according to the disclosure, a most even distribution of the load is accomplished, since in the case of four ball circulations, load bearing balls are existing at each axial position. As such, the axial load can be distributed very evenly to the load bearing balls, so that no local load peaks will occur.

Due to the distribution of the load bearing balls, which results from the positioning of the deflecting bodies, there is another effect in that the Hertz's pressing of the balls in the respective channel circulations, in which the balls have a respective point contact with the ball-accommodating grooves of the spindle and nut, may also be very evenly distributed. This does no doubt results from the fact, that all balls may bear a load within the load bearing angular sections due to the very even load distribution, i.e. no ball in this section is kept from bearing load.

Another advantage of this alignment geometry or respectively, of the distribution according to the disclosure is furthermore, that possible transverse forces, that issue on the nut, can also be absorbed very homogeneously along the entire circumference of the nut. This means that independent from the direction from which the possible transverse force issues on the nut, the absorbing of that load may be evenly distributed.

The very even distribution of the load, as well as the even distribution of the Hertz's pressing, may be by the particular advantage of an improvement of the durability, which can be improved in comparison with e.g. the before-mentioned prior art. Because due to the even distribution of the load, the balls will at no position be overly strained.

In further development of the disclosure, it can be intended that the position of an inlet opening of a deflecting body is axially offset in circumferential direction in relation to the position of an outlet opening of an adjacent but offset deflecting body by an angular section, so that the transfer paths of two adjacent deflecting bodies do not overlap each other when viewed in axial direction. The deflecting bodies lead the balls from one channel section into the adjacent channel section. To some extent, the ball-return channel inevitably runs diagonally to the longitudinal axis of the nut, so that the balls are consequently deflected by a corresponding angle and lead from one channel section into the other one. This angle may be dependent on the position of the inlet and of the outlet opening at the respective deflecting body. The angle should not be too big, so that the angle section, in which the balls are within the ball channel and in which they are thus load bearing, is as big as possible.

The inlet and the outlet openings may be positioned in such a way, that the transfer sections of two adjacent deflecting bodies do not overlap when viewed in axial direction. When observed in axial direction, there may be a circumferential offset of an inlet opening of one deflecting body towards the outlet opening of the adjacent deflecting body. It is thus purposed that the positions of the inlet and of the outlet openings do not fall on the same position, rather a corresponding offset is also provided in this case, so that the transfer paths do not overlap when viewed in axial direction.

This angle section, or also the offset, should range between 5 and 20°. This number refers to e.g. the respective center of the inlet and outlet opening. This angle section should range between 10 and 15°.

The angle, around which the balls are deflected within a deflecting body should range between 100 and 120°, e.g. again with reference to the center of the respective inlet and outlet opening. Thus, the resulting angle section, in which the balls are load bearing within the ball channel, ranges between 240-260°.

At least four deflecting bodies may be provided, which are, as it was described before, positioned towards each other at an offset in circumferential direction by 130°, respectively.

The design of the ball screw drive with four deflecting bodies may be advantageous.

### BRIEF DESCRIPTION OF THE DRAWINGS

The disclosure will be described in the following embodiments with reference to the drawings. The drawings are schematic depictions and show:

FIG. 1 a perspective view of a ball screw drive according to the disclosure,

FIG. 2 a longitudinal sectional view of the ball screw drive from FIG. 1,

FIG. 3 a depiction of several sectional views through the nut that is also depicted in FIG. 3 in various sectional planes, and

FIG. 4 a diagram to illustrate the positions of the individual deflecting bodies.

### DETAILED DESCRIPTION

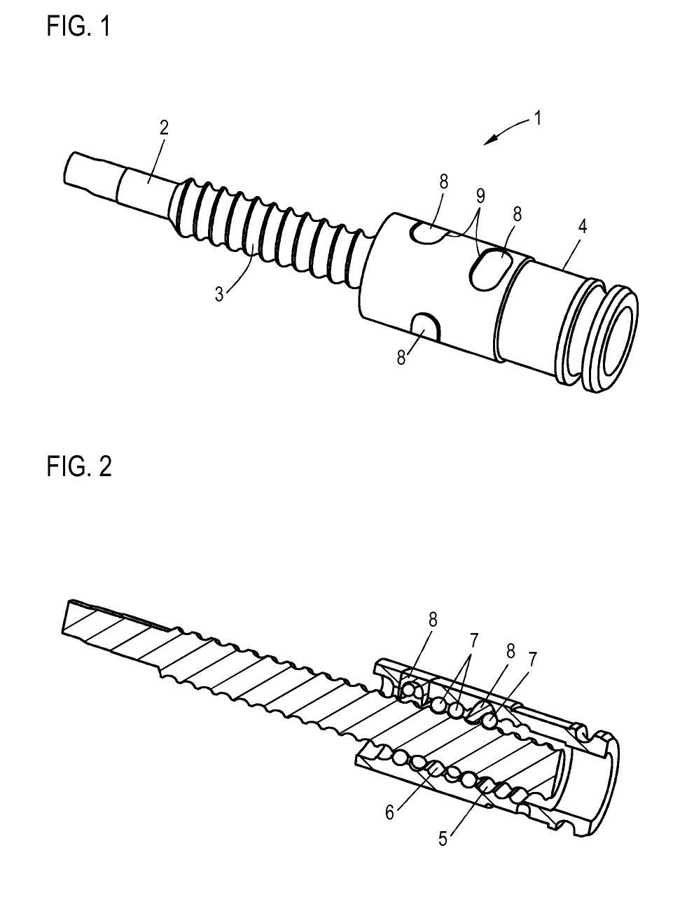

FIG. 1 depicts a ball screw drive 1 according to the disclosure, comprising a threaded spindle 2, which has a ball-accommodating groove 3 that is formed on the outer surface of the threaded spindle 2 which extends in a threaded manner along the threaded spindle 2. The ball screw drive 1 further comprises a nut 4, which has a ball-accommodating groove 5 that is formed on the inner surface of it (see FIG. 2). The two ball-accommodating groves 3 and 5 of the threaded spindle 2 and of nut 4 combine to form a ball channel 6 which runs between the threaded spindle 2 and the nut 4. A plurality of balls 7 are accommodated within ball channel 6 by using the nut 4 that is guided on the threaded spindle 2 in a manner that is well-known as such.

In the depicted example, a total of four deflecting bodies 8 are accommodated in corresponding pockets 9 at nut 4, on the side of the nut. These deflecting bodies 8 feature an inlet opening and an outlet opening in a well-known manner, between which a channel is formed. They serve to transfer the balls 7 from one section of the ball channel 6 into an adjacent section of the ball section 6. Since four deflecting bodies 8 are intended, as it was described, a total of four rows of balls are thus formed, which run along a thread of the ball channel that extends for approximately 360° and from which a part runs within the ball channel 6 itself, consequently in a load bearing manner, while another part is transferred in that moment or which is accommodated within the deflecting body 8. During operation, or when the threaded spindle 2 rotates in relation to nut 4, balls continuously enter through the respective inlet openings of a deflecting body 8 into the deflecting body, while corresponding balls are returning via the outlet opening of the respective deflecting body into the ball channel at the same time. Thus, this results in a total of four continuous ball circulations.

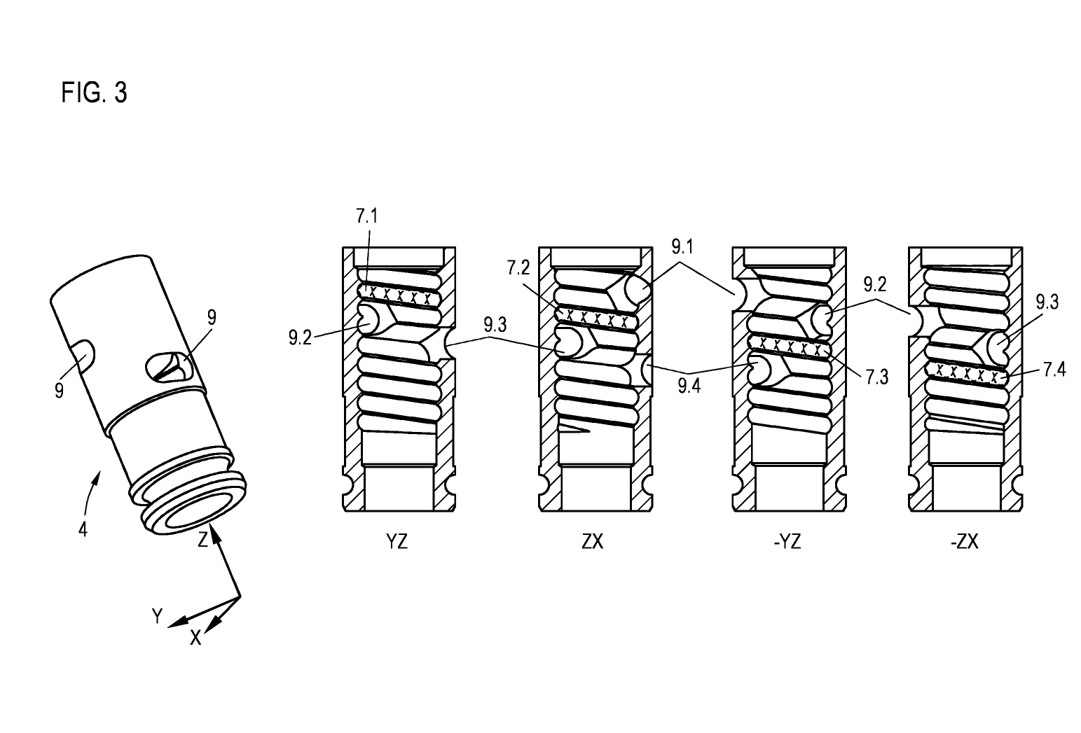

FIG. 3 depicts a view of nut 4 without deflecting body 8, so that the corresponding pocket 9 can be seen. A coordinate system with the corresponding axes X, Y, Z is depicted.

Furthermore, FIG. 3 depicts four sectional views through nut 4, which lie in different planes, and which depict the respective sectional body in respective views from opposite directions. The pockets 9 are depicted in the sectional views in the respective planes are seen on the one hand, as well as the respective rows of balls, that are “assigned” to one pocket, which include a plurality of balls 7, respectively.

Since one respective deflecting body 8 is of course arranged within each pocket 9, the respective row of balls may be assigned to the corresponding deflecting body, and runs through this one. The respective pockets and row are assigned to each other and are intended to be axially arranged behind each other and with a distance towards each other. In order to be able to differentiate them, the first row of balls is referenced with 7.1 and the assigned pocket with 9.1, the row of balls that is following next with 7.2 and the pocket with 9.2, the furthermore following row of balls with 7.3 and the pocket with 9.3 and the last row of balls with 7.4 and the assigned pocket with 9.4.

The first sectional view that is depicted on the left lies in the YZ plane. In this view, the first row of balls 7.1 is indicated by using the depiction of the dashed balls. The corresponding pocket 9.1 can be found in the two sectional views within the ZX and −YZ plane. It inevitably lies within the same plane as the row of balls 7.1, since the deflecting body 8 which transfers the balls is located in the pocket, as it was described.

The second sectional view from the left lies in the ZX plane and depicts the second row of balls 7.2. The corresponding partial views of the assigned pocket 9.2 can be found in the YZ, −YZ and −ZX planes. Of course it again lies within the plane of the second row of balls 7.2.

The third sectional view in the −YZ plane depicts the third row of balls 7.3. The assigned pocket 9.3 is shown in the corresponding partial sectional views in the depictions of planes YZ, ZX and −ZX.

Finally, the fourth row of balls 7.4 is shown in the sectional depiction of plane −ZX, the assigned pocket 9.4 is shown in the depictions of planes ZX and −YZ.

In accordance with the disclosure, pockets 9.1-9.4 and thus the respective deflecting bodies may be arranged in a defined manner in that they are set at an offset in relation to one another.

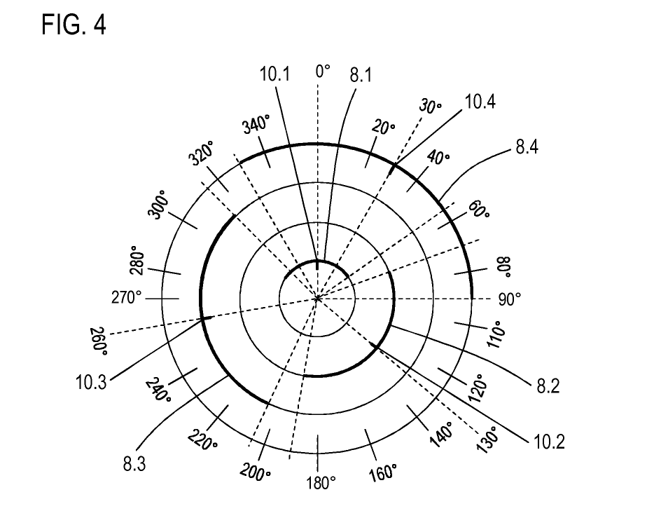

With reference to one body point that is the same for all deflecting bodies 8, the deflecting bodies 8 are positioned towards each other with an offset of 490°, when viewed in the circumferential direction of the channel. From a merely axial view, the deflecting bodies are thus set at an offset of 130° towards each other. The corresponding arrangement is depicted in FIG. 4. For the sake of greater clarity, the respective deflecting bodies are depicted on differed radii, but of course they are all positioned on the same respective radius.

The four deflecting bodies 8.1, 8.2, 8.3 and 8.4 are shown. Each deflecting body 8.1-8.4 is depicted with a center point 10.1, 10.2, 10.3, 10.4, which refers to e.g. the exact center point that can be derived from the longitudinal and transverse expansion of the deflecting body. This respective center point is merely chosen as a point of reference, in order to explain the positioning or respectively, the corresponding angle offset according to the disclosure.

In the depiction according to FIG. 4, the center point 10.1 of deflecting body 8.1 is positioned at 0°.

Center point 10.2 of the second deflecting body 8.2, that is following next to it, is noticeably arranged with an offset of 130° in relation to center point 10.1 of the first deflecting body 8.1.

This offset of 130° in circumferential direction can be derived from a mere axial observation. If the ball channel 6 is followed, center point 10.2 would be offset to center point 10.1 exactly 490° along the ball channel, or also by an offset of 1.36 threads of ball channel 6.

Likewise, center point 10.3 of the third deflecting body 8.3 is positioned with an axial offset of 130° in relation to center point 10.2 of deflecting body 8.2. Alongside the ball channel, the offset is again 490°.

Finally, center point 10.4 of the fourth deflecting body 8.4 is positioned with an axial offset of 130° in relation to center point 10.3 of deflecting body 8.3, which corresponds to a ball channel circulation of 490° also in this case.

Furthermore, the circumferential lengths of the respective deflecting bodies 8.1-8.4 are depicted in FIG. 4, or in other words, the corresponding angles around which the deflecting bodies 8.1-8.4 stretch. In the area of their respective ends, there is an opening in each case, which is an inlet opening or an outlet opening, depending on the rotation direction.

Each deflecting body 8.1-8.4 extents around approximately 115°. As it can be seen in FIG. 4, two adjacent deflecting bodies do not overlap. Rather, the respective ends of two adjacent deflecting bodies are positioned with an offset towards each other by an angle section. This angle section, i.e. the circumferential offset, amounts to approximately 15° for a circulatory extension of deflecting body 8.4, as it can be derived from the dashed line. But since the deflecting bodies feature a certain depth, after they have been inserted into the pockets and since they access into the area of the ball channel 6 by using the defined inlet opening and outlet opening with corresponding inlet and outlet sections, the angle section is radially getting slightly smaller when viewed in radial direction towards the inside.

Nevertheless, two respective adjacent deflecting bodies are always arranged in such a way that they do not overlap each other when viewed in axial direction.

Since the outer ends of the deflecting bodies 8.1-8.4 connect to the respective inlet and outlet opening, the corresponding, adjacent openings of two adjacent deflecting bodies may be arranged in circumferential direction with a corresponding offset.

It can furthermore be seen from FIG. 4, that the angle around which the balls are deflected within a deflecting body, amounts to 115°, as a result of the geometry of the deflecting body. In turn, the balls may be accommodated along a channel section of approximately 245° within ball channel 6, and accordingly run in it in a load bearing manner.

Consequently, due to the 490° positioning of the deflecting bodies according to the disclosure, an optimal distribution of the axial load, which is issuing on the balls, is achieved (see also FIG. 4 in this regard). Because due to the fact, that the adjacent deflecting bodies do not overlap each other, the balls are optimally distributed around the circumference, so that the axial load is very evenly distributed on the load bearing balls around the circumference. Due to this very even load distribution, all balls that are within the ball channel, may be load bearing, or none of these balls may not be exposed to the load. The result is, that the Hertz's pressing of the balls, which are in point contact with the ball-accommodating grooves, is also evenly distributed.

The even load distribution and the even Hertz's pressing may lead to a significant increase in the durability. A further result from the distribution of the deflecting bodies according to the disclosure and thus also from the distribution of the load bearing balls within the ball channel is, that the ball screw drive according to the disclosure can also absorb transverse forces in a very even manner, independent from that fact, at which circumferential position these forces are issuing. A corresponding amount of load bearing balls may be provided at each circumferential position, which can absorb the transverse load. The ball screw drive 1 according to the disclosure is thus not only optimized with regard to an even absorbing or respectively, distribution of the axial load, but also with regard to an even absorbing of a transverse load.

### REFERENCE SIGN LIST

1 Ball screw drive

2 Threaded spindle

3 Ball-accommodating groove

4 Nut

5 Ball-accommodating groove

6 Ball channel

7 Ball

7.1-7.4 Row of balls

8 Deflecting body

8.1-8.4 Deflecting body

9 Pocket

10.1-10.4 Center point

1. A ball screw drive, comprising:
a threaded spindle that includes a first ball-accommodating groove formed on an outer surface of the threaded spindle; and
a nut arranged on the threaded spindle that has a second ball-accommodating groove that is formed on an inner surface of the nut, wherein the first and second ball-accommodating grooves combine to form a ball channel; and
a plurality of balls arranged in the ball channel and configured to guide the nut on the threaded spindle wherein one or more deflecting bodies are arranged on the nut and configured to transfer from one segment of the ball channel into an adjacent segment of the ball channel, wherein the one or more deflecting bodies are offset from each other by angle segments in a channel revolving direction, wherein the deflecting bodies are positioned at an offset from each other with respect to a body point that is the same for all deflecting bodies.

2. The ball screw drive of claim 1, an inlet opening position of a deflecting body is axially offset in circumferential direction in relation to an outlet opening position of an adjacent but offset deflecting body, wherein transfer paths of two adjacent deflecting bodies do not overlap each other when viewed in axial direction.

3. The ball screw drive of claim 2, wherein the angle segments range between 5 and 20°.

4. The ball screw drive of claim 2, wherein the angle segments range between 10 and 15°.

5. The ball screw drive of claim 1, wherein an angle by which the balls are deflected in one or more deflecting bodies ranges between 100 and 120°.

6. The ball screw drive of claim 1, wherein the ball screw drive includes at least four deflecting bodies.

7. A ball screw drive, comprising:
a threaded spindle that includes an outer surface having a first groove; and
a nut including an inner surface having a second groove configured to correspond with the first groove to form a ball channel configured to accommodate a ball, wherein the nut further includes two or more deflecting bodies configured to transfer the ball from one segment of the ball channel into an adjacent segment of the ball channel, wherein the two or more deflecting bodies are offset from each other by angle segments in a channel revolving direction.

8. The ball screw drive of claim 7, wherein the two or more deflecting bodies are positioned at the offset from each other with respect to a body point that is same for all deflecting bodies.

9. The ball screw drive of claim 7, wherein the ball channel runs diagonally to a longitudinal axis of the nut.

10. The ball screw drive of claim 7, wherein the two or more deflecting bodies are offset at 490°.

11. The ball screw drive of claim 7, wherein the two or more deflecting bodies are accommodated in corresponding pockets.

12. A ball screw drive, comprising:
a threaded spindle that includes an outer surface including a first ball-accommodating groove;
a nut configured to be guided on the threaded spindle and includes two or more deflecting bodies not aligned to each other in an axial direction, wherein the nut further includes an inner surface including a second ball-accommodating groove, wherein the first and second ball-accommodating groove form a ball channel; and
one or more balls arranged to transfer from one segment of the ball channel into an adjacent segment of the ball channel.

13. The ball screw drive of claim 12, wherein the two or more deflecting bodies are offset from each other by angle segments in a channel revolving direction.

14. The ball screw drive of claim 13, wherein the two or more deflecting bodies are positioned at an offset from each other with respect to a body point that is the same for all deflecting bodies.

15. The ball screw drive of claim 12, wherein the two or more deflecting bodies includes a first deflecting body that includes an inlet opening coupled via the ball channel to an outlet, wherein the outlet includes an opening into an adjacent segment of the ball channel.

16. The ball screw drive of claim 15, wherein an inlet opening position of the first deflecting body is axially offset in circumferential direction in relation to an outlet opening position of an adjacent deflecting body by an angular section.

17. The ball screw drive of claim 16, wherein transfer paths of two adjacent deflecting bodies do not overlap each other when viewed in axial direction.

18. The ball screw drive of claim 12, wherein the two or more deflecting bodies include at least one set of adjacent openings corresponding to adjacent deflecting bodies that are arranged in circumferential direction with a corresponding offset

19. The ball screw drive of claim 12, wherein the plurality of deflecting bodies are arranged at a position that is offset in circumferential direction to that of all other deflecting bodies.

20. The ball screw drive of claim 12, wherein the two or more deflecting bodies are offset at 490° from each other with respect to a body point that is the same for all deflecting bodies.
